(19) United States
(12) Patent Application Publication
(10) Pub. No.: US 2013/0067731 A1
(43) Pub. Date: Mar. 21, 2013

(54) PART MOUNTING APPARATUS

(71) Applicant: GENERAL ELECTRIC COMPANY, Schnectady, NY (US)

(72) Inventors: JOSEPH GARFIELD ALBANESE, ROTTERDAM JCT, NY (US); DONALD JOSEPH BALDWIN, GALWAY, NY (US); JOSHUA L. MARGOLIES, NISKAYUNA, NY (US)

(73) Assignee: GENERAL ELECTRIC COMPANY, SCHENECTADY, NY (US)

(21) Appl. No.: 13/673,514

(22) Filed: Nov. 9, 2012

Related U.S. Application Data
(62) Division of application No. 12/354,333, filed on Jan. 15, 2009, now abandoned.

(51) Int. Cl. B65G 15/30

(52) U.S. Cl. CPC B65G 15/30
USPC 29/700

(57) ABSTRACT

A part processing apparatus includes a plurality of part mounting devices, each of which is rotatable. Parts are mounted on the plurality of part mounting devices, and the parts are rotated on the devices during a part processing operation. A rotational input shaft is coupled to all of the plurality of part mounting devices so that all of the part mounting devices rotate together. A part processing robot may be movable between a plurality of positions located adjacent each of the part mounting devices. Alternatively, the part mounting devices may be movable to a plurality of different positions so that each of the part mounting devices can be located adjacent to the part processing robot.

### CROSS-REFERENCE TO RELATED APPLICATIONS

This Application is a Divisional of Application of U.S. patent application Ser. No. 12/354,333 filed Jan. 15, 2009, the contents of which is incorporated herein by reference.

### BACKGROUND OF THE INVENTION

The disclosure relates to parts processing systems which utilize a robot to conduct a part processing operation.

Various robotic devices are now used to process parts, and the processing operations can include a wide variety of different operations. For instance, robots are now commonly used to conduct painting or coating operations on parts.

One typical background art processing system is used to apply a thin coating layer to a part. Such a system would include a part mounting apparatus and a robot that conducts the coating operation. The robot could include multiple movable arms. A spray coating head attached to the arms could include a spray nozzle used to spray a coating onto a part held by the part mounting apparatus.

The part mounting apparatus could include a rotatable part mounting device. The part mounting device would be mounted on a rotating shaft which is itself mounted on the part mounting apparatus. Typically, a motor or other rotation driving device would be coupled to the rotating shaft to impart rotational motion to the part mounting device, and thus the part itself. As a result, the part mounting device and the part can be rotated during the coating process.

The rotation of the part mounting device would be controlled by a controller. In some instance, the controller might also control movements of the robot. The robot could be configured so that the spray head can be translated in the X, Y and Z directions, and/or such that the spray head can be rotated about these axes. Of course, the robot might be capable of moving the spray head in only a sub-set of these directions.

During a spray coating operation, it is necessary to move the spray head on the robot relative to the part itself as a coating material is sprayed onto the part. The relative motion between the spray head and the part can be accomplished by moving only the spray head, or only the part, or both the spray head and the part. In any event, it is typically desirable to ensure that the spray nozzle remains at a fixed distance from the surface of the part during the spraying operation, and that the speed of the relative motion remains uniform. This helps to produce a coating on the part that has a uniform thickness.

The speed of the relative motion, the separation distance, and a variety of other parameters such as the coating material spray rate can be selectively varied to control the thickness of the coating.

In some types of background art spray coating systems, the part coating operation is also conducted under carefully controlled environmental conditions. For instance, such a system could be used to conduct a flame spray coating process where a powdered material is sprayed through a flame or an electrical arc before the material strikes and adheres to the part surface. Such spray coating operations are often conducted at extremely high temperatures. For instance, the robot, the part, and the part mounting apparatus could all be located in an environmental chamber which is heated to above 1000° F. before the spray coating operation is performed.

During coating operations which are conducted at elevated temperatures, it is necessary to first mount the part on the part mounting device, and then the environmental chamber must be raised to the elevated temperature at which the spray coating operation is to be conducted. After the spray coating operation has been finished, the temperature of the chamber must be gradually reduced before the chamber can be opened, the spray coated part removed, and a new part mounted on the part mounting device for a another spray coating operation.

### BRIEF DESCRIPTION OF THE INVENTION

In one aspect, the invention may be embodied in a part mounting apparatus that includes a base frame, a rotation input shaft mounted on the base frame, and a plurality of part mounting devices that are rotatably mounted on the base frame, wherein the part mounting devices are operatively coupled to the rotation input shaft such that all of the part mounting devices rotate together with the rotation input shaft.

### BRIEF DESCRIPTION OF THE DRAWINGS

FIG. 1 is a diagram illustrating a background art part processing system;

FIG. 2 is an illustration of a part mounting apparatus which can be used in the part processing system shown in FIG. 1;

FIG. 3 illustrates a first embodiment of a part processing apparatus that can conduct processing operations on multiple parts held on a single part mounting apparatus;

FIG. 4 is an elevation view of the part mounting apparatus shown in FIG. 3;

FIG. 5 illustrates another embodiment of a part mounting apparatus that could be used in the part processing system shown in FIG. 3;

FIG. 6 illustrates another embodiment of a part mounting apparatus that could be used in the part processing system shown in FIG. 3;

FIGS. 7a and 7b illustrate yet another embodiment of a part mounting apparatus that could be used in the part processing system shown in FIG. 3.

### DETAILED DESCRIPTION OF PREFERRED EMBODIMENTS

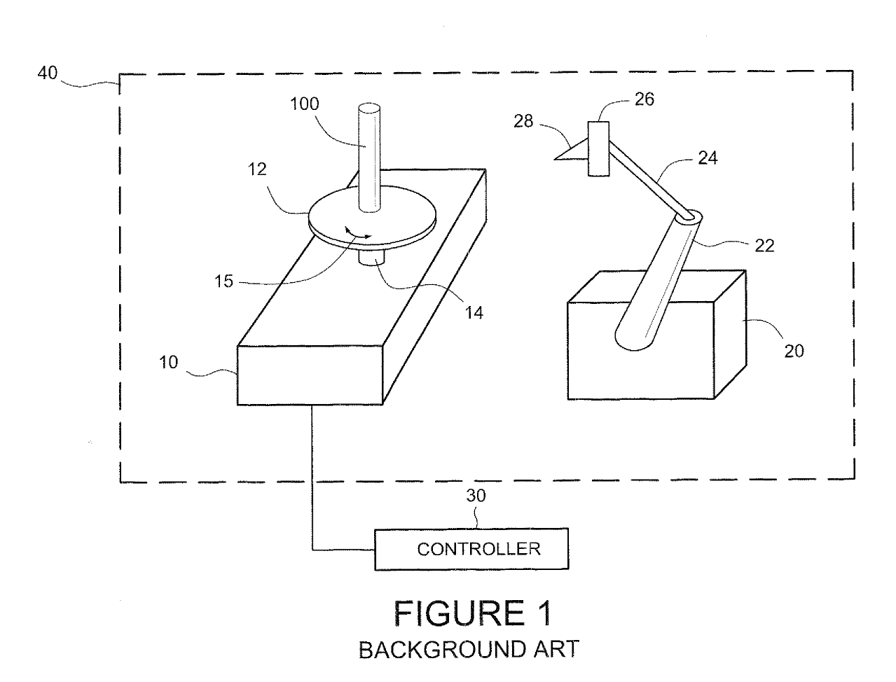

FIG. 1 shows a typical background art part processing system which is used to apply a coating layer to a part. The system includes a part mounting apparatus 10, and a robot 20 that conducts the coating operation. The robot includes multiple movable arms 22 and 24. A spray coating head 26 includes a spray nozzle 28 which is used to spray a coating onto a part 100.

The part mounting apparatus includes a rotatable part mounting device 12. The part mounting device 12 is mounted on a rotating shaft 14 which is itself mounted on the part mounting apparatus 10. Typically, a motor or other rotation driving device would be coupled to the rotation shaft 14 to impart rotational motion to the part mounting device 12 and the part itself 100. As a result, the part mounting device 12 and the part 100 can be rotated in the direction of the arrows 15 during the coating process.

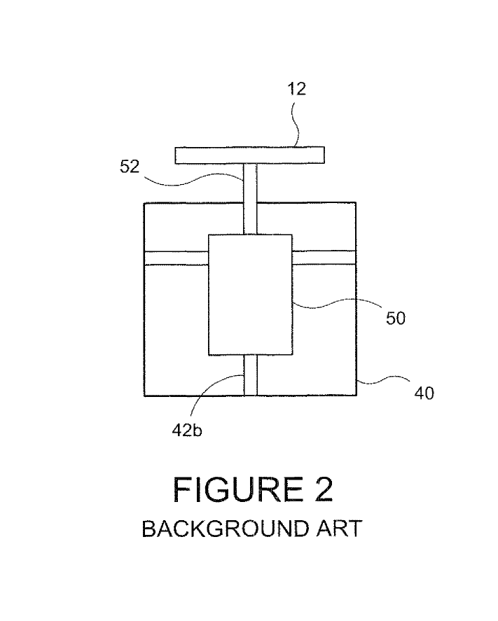

As shown in FIG. 2, a motor 50 could be located inside the part mounting apparatus 10, and a rotational shaft 52 of the motor 50 would be coupled to the part mounting device 12. This would allow the motor 50 to rotate the part mounting device 12. The rotational speed of the motor, and thus the part mounting device 12, would be controlled by a controller 30. In some instances, the controller 30 might also control movements of the robot 20.

During a spray coating operation, it is necessary to move the spray head on the robot relative to the part surface as a coating material is sprayed onto the part. In some instances, the relative motion between the spray head and the part can be accomplished by moving only the spray head, or only the part. Alternatively, both the part and the spray head could be moved at the same time to achieve the relative motion. In any event, it is typically desirable to ensure that the spray nozzle 28 remains at a fixed distance from the surface of the part 100 during the spraying operation, and that the speed of the relative motion remains uniform. This helps to produce a coating on the part that has a uniform thickness.

The speed of the relative motion, the separation distance, and a variety of other parameters such as the spray rate can be selectively varied to control the thickness of the coating.

As explained above, in some instances, a spray coating process may be accomplished inside an environmental chamber 40 under carefully controlled environmental conditions. This often involves heating the environmental chamber 40 up to an elevated temperature before the spray coating process is conducted.

If multiple parts must be coated, and the part mounting apparatus is only capable of holding and rotating a single part, then a considerable amount of time is used to heat the chamber up to the operating temperature, and then cool the chamber back down before another part can be mounted and coated.

To reduce the overall process time required to coat multiple parts, the inventors have developed a part mounting apparatus that is capable of holding and rotating multiple parts at the same time. When such a part mounting apparatus is used, multiple parts are mounted on the apparatus, and the parts are all heated up to the desired process temperature at the same time. The parts are then coated, and the environmental chamber is cooled and the parts are removed. Because multiple parts are coated during a single heating and cooling cycle of the environmental chamber, significant time savings are achieved in coating the multiple parts.

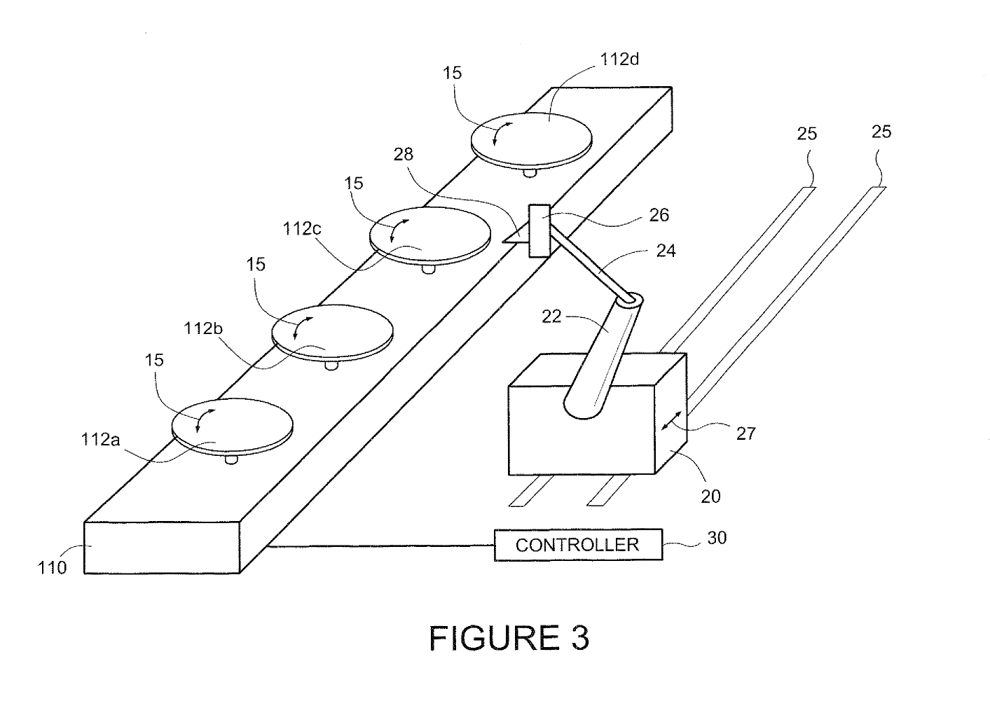

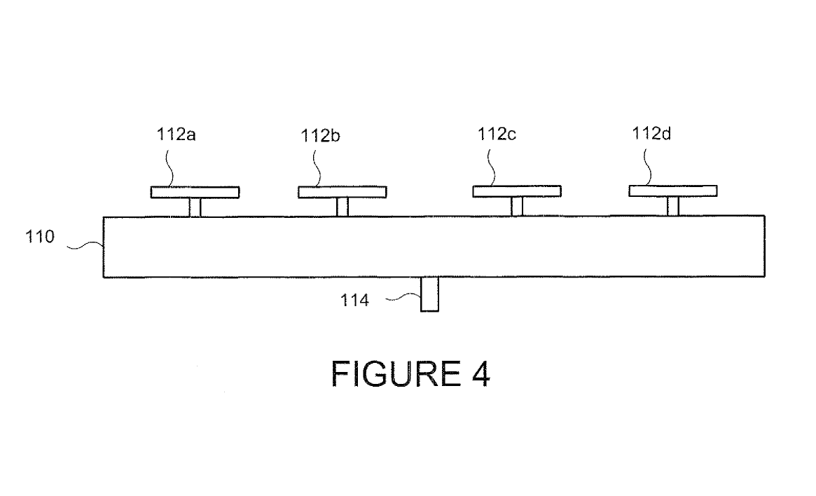

A first embodiment of a part mounting apparatus capable of holding multiple parts is illustrated in FIG. 3. As shown therein, the part mounting apparatus 110 includes a plurality of part mounting devices 112a, 112b, 112c, 112d. The part mounting apparatus 110 is also shown in an elevation view in FIG. 4. As shown therein, the part mounting apparatus 110 includes a rotational input shaft 114. The rotational input shaft 114 is operatively coupled to the rotational shafts connected to each of the part mounting devices 112a, 112b, 112c, 112d. The rotational input shaft 114 is then connected to a single motor. As a result, as the motor rotates the rotation input shaft 114, all of the part mounting devices also rotate at the same rotational speed.

In some embodiments, the part mounting apparatus shown in FIG. 4 would be specifically constructed so that rotational movement of the rotation input shaft 114 in a particular rotational direction will cause rotation of all four of the part mounting devices in the same rotational direction. Furthermore, the rotational speed of the rotation input shaft will be exactly matched by the rotational speed of each of the part mounting devices.

In alternate embodiments, the part mounting devices may rotate in different directions. Also, in some embodiments, the motor and the rotational input shaft might rotate at one rotational speed, while the part mounting devices rotate at a different rotational speeds.

It will typically be desirable for all of the part mounting devices to rotate at the same rotational speed. However, in some instances, it may be desirable for various ones of the part mounting devices to rotate at different rotational speeds.

During a coating operation, the robot would be moved adjacent a part located on a first part mounting device 112a, and a coating operation would be performed on the part. This would typically include rotating the part at a fixed rotational speed, and moving the spray head 28 of the robot relative to the part while a coating material is sprayed onto the part. Once a first part has been coated, the robot would be moved along rails 25 in the direction of the arrows 27 so that the robot is brought adjacent a second part on a second part mounting device 112b. A coating operation would then be performed on the second part.

In alternate embodiments, the robot could remain stationary, and the part mounting device could be moved to position different ones of the parts held by the part mounting devices adjacent to the robot.

In some embodiments, it will be desirable to rotate all of the parts at the same rotational speed during the coating processes. However, in some instances, it may be desirable to coat a first part while it is rotating at a first speed, and then coat a second part while it is rotating at a second speed. In this instance, the controller 30 would be used to vary the rotational speed of a motor that is coupled to the part mounting apparatus 100 after a first part has been coated, and before the second part is coated.

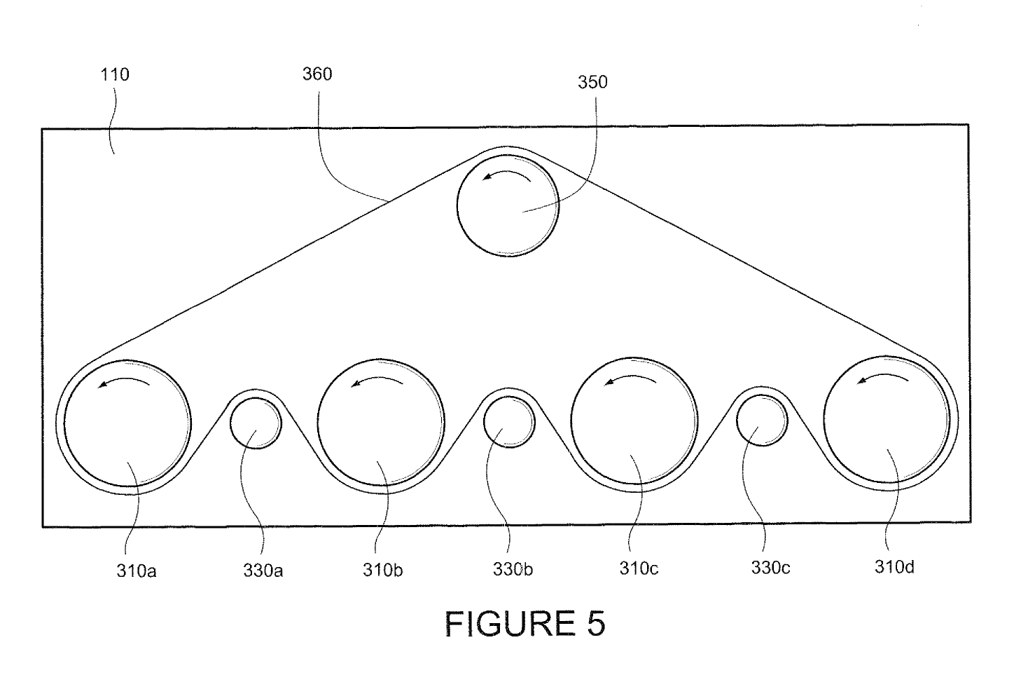

FIG. 5 shows one embodiment of a part mounting apparatus 110 that is constructed so that all of the part mounting devices rotate at the same speed, and in the same direction. In this embodiment, a plurality of part mounting device rotation shafts 310a, 310b, 310c, 310d are all coupled to a flexible drive belt 360. A plurality of idler pulleys 330a, 330b, 330c are located between each of the plurality of part mounting device rotation shafts. The drive belt 360 winds in a serpentine fashion between each of the part mounting device rotation shafts and the intervening idler pulleys.

The drive belt also passes around a tension pulley 350. A position of the tension pulley 350 can be adjusted to ensure that sufficient tension is maintained in the drive belt 360. In preferred embodiments, the tension pulley would be spring loaded so that it maintains a predetermined tension in the drive belt at all times.

In an arrangement as shown in FIG. 5, the rotation input shaft of the part mounting device 110 could be coupled to any one of the part mounting device rotation shafts 310a, 310b, 310c, 310d. Alternatively, the rotation input shaft could be coupled to one of the idler pulleys 330a, 330b, 330c. In still other embodiments, the rotation input shaft could be coupled to the tension pulley 350.

In addition, the drive belt 360 could be directly in contact with the part mounting device rotation shafts upon which the part mounting devices are attached. Alternatively, the drive belt could be in contact with separate pulleys which are attached to the part mounting device rotation shafts. Regardless, provided that the outside diameter of the portions of the part mounting device rotation shafts or pulleys are the same for each of the different part mounting device rotation shafts, the part mounting device rotation shafts would all rotate at the same rotational speed, and in the same rotational direction.

In alternate embodiments a drive belt as illustrated in FIG. 5 could be wound upon different combinations of part mounting device rotation shafts and idler pulleys to achieve the same basic concept of keeping each of the part mounting devices rotating at the same rotation speed and the same rotational direction.

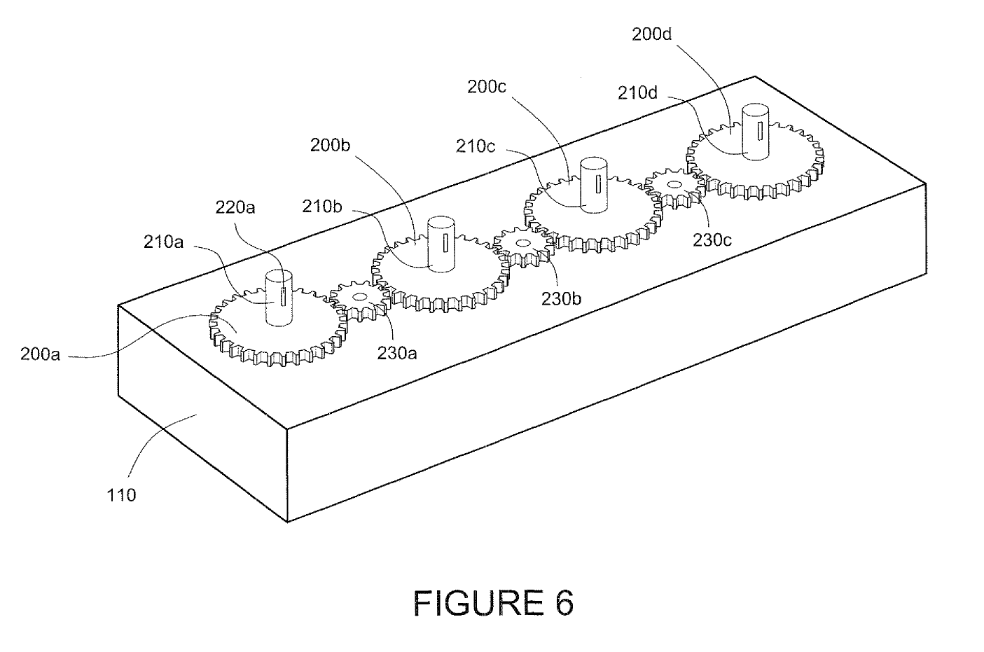

FIG. 6 illustrates another embodiment of a part mounting apparatus 110 that is constructed so that all of the part mounting devices rotate together at the same rotational speed, and in the same rotational direction. In the embodiment shown in FIG. 6, a plurality of rotational shafts 210a, 210b, 210c and 210d are rotationally mounted on the part mounting device 110. The rotational shafts are attached to a plurality of part mounting device gears 200a, 200b, 200c, 200d. In addition, a plurality of idler gears 230a, 230b, 230c are located between and are interfaced with the plurality of part mounting device gears.

The rotation input shaft 114 of the part mounting device 110 would be coupled to one of the plurality of part mounting device rotation shafts 210a, 210b, 210c, 210d. Rotation of the part mounting device rotation shaft coupled to the rotation input shaft would then be transmitted to the idler gears and the other part mounting device gears. In this manner, part mounting devices that are attached to each of the part mounting device rotation shafts would all rotate in the same rotational direction as the rotation input shaft. Further, if the number of gear teeth on the idler gears and the part mounting device gears is properly selected, all of the part mounting device rotation shafts would rotate at the same rotational speed.

The size and number of teeth on the various gears could be selectively varied to achieve different aims. For instance, the gear train could be configured so that some part mounting device shafts rotate at different speeds than other part mounting device shafts. In addition, in alternate embodiments, the rotation input shaft 114 could be coupled to one of the idler gears 230a, 230b, 230c. Although this would result in the part mounting device rotation shafts rotating in a direction opposite to that of the rotation input shaft.

FIG. 6 also illustrates that a keyway 220a could be formed on each of the part mounting device rotation shafts to help couple the part mounting device rotation shafts to associated part mounting devices. Of course, other attachment devices can also be provided.

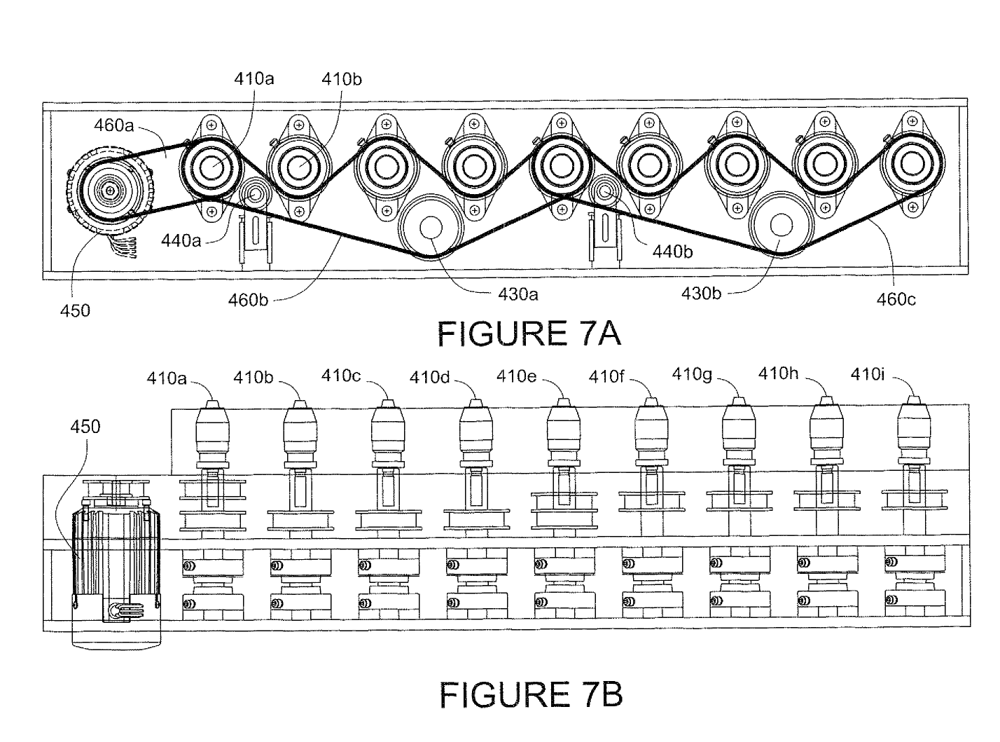

FIGS. 7a and 7b illustrate another part mounting apparatus that is capable of rotating multiple parts at the same time. This embodiment includes a motor 450 mounted at one end of the apparatus. A plurality of part mounting devices 410a-i are also mounted on the apparatus. A first drive belt 460a is wound upon a pulley on the motor and a pulley on the first part mounting device 410a. A second drive belt 460b is wound upon pulleys connected to the first five part mounting devices 410a-e. A third drive belt 460c is wound upon pulleys on the last five part mounting devices 410e-i. First and second idler pulleys 430a and 430b keep the lower portions of the second and third drive belts from interfering with the part mounting devices 410a-i. In addition, there are two tension pulleys 440a and 440b that are used to keep a proper amount of tension in the second and third drive belts.

With the part mounting apparatus shown in FIGS. 7a and 7b it is possible to mount nine separate parts on the part mounting apparatus, so that spray coating operations can be performed on all nine parts during a single temperature cycle of the environmental chamber. As mentioned above, this can result in significant time savings as compared to a process where only a single part is processed during each temperature cycle of the environmental chamber. In addition, for the reasons explained below, the fact that the coatings will be applied to all of the parts under essentially the same operating conditions can also be used to advantage.

One application for a part mounting apparatus as disclosed in this application would be in connection with applying coatings to parts as part of a testing process for the coatings themselves. A coating process as described above can be used to apply special protective coatings to parts that will be used in extreme operating environments. For instance, the coatings could be applied to parts, such as turbine blades, that will be installed in turbine engines. The coatings would help such parts withstand the high temperatures, frictional forces, and extreme accelerations which are applied to parts within a turbine engine.

The manufacturers of such parts experiment with different coatings to determine the best coating parameters for providing the desired protection to the parts. For instance, the thickness of the coatings, the mixtures of the materials used, the temperatures at which the coatings are applied, and a variety of other factors can be varied to apply different type of coatings to the parts.

During typical coating test procedures, identical test objects are coated with a variety of different coatings, and the coated parts are then subjected to extreme environments to see how well the coatings help to protect the parts. Cylindrical pins are often used as the parts in such tests.

In known coating test procedures, one would apply the same type of coating to two or three of the cylindrical pins. Then a different coating will be applied to two or three other pins. The two sets of pins would then be subjected to the same extreme environmental conditions to determine which coating was better at withstanding the extreme conditions. Of course, additional sets of cylindrical pins could also be prepared with alternate coatings.

In the past, when one wished to coat multiple test pins, each pin would be coated during a separate thermal cycle of the environmental chamber because only a single pin could be mounted on the part mounting device at any one time. Because of this, it was difficult, and sometimes impossible, to ensure that two or three pins would receive virtually the same coatings. Small variations in the temperature of the environmental chamber and in the operating conditions of the spray head would usually result in the coatings on any two pins being slightly different, even though the object was to have the coatings be virtually identical. The mere passage of time between the coating of one pin, and the subsequent coating of a second pin could result in changes occurring in the coating materials or in the equipment used to conduct the coating operation.

Likewise, if a testing procedure was intended to coat two or three pins with a particular material, and then coat two or three more pins with the same material, but with slightly altered spraying conditions, it was difficult to ensure that the operating conditions during each spray coating operation were exactly right to ensure that the small differences in the coating operations were truly present during each respective coating operation.

However, a part mounting apparatus as illustrated in FIGS. 3-7a allows spray coating processes to be performed on multiple pins during a single thermal cycle of the environmental chamber, where each coating operation performed in rapid succession over a relatively short prior of time. This means than when it is desirable to coat two or three pins with identical coatings, the spray machine operating conditions will be virtually identical when three pins are coated in rapid succession. In addition, when it is desirable to coat two or three pins with first coating parameters, and then coat two or three more pins with slightly different coating parameters, the actual desired coating parameters are easier to achieve. In other words, the fact that all pins are coated in rapid succession during a single thermal cycle of the environmental chamber helps to ensure that the conditions are highly repeatable when desired, and that the conditions can be very slightly varied in a precise manner.

Examples of process parameters that could be varied from one coating process to the next include the rotational speed of the part, the separation distance between a spray head and the part, the flow rate of the coating material, the velocity of the coating material as it is expelled from the spray head to the part, and the coating material itself. In some instances, a spray head may include two or more material ports for injecting two materials into a stream directed at a part. Thus, one could vary the relative amounts of the materials being added to the stream.

Some spray heads will spray a material through an electrical arc to heat the material to an extremely high temperature before it hits the part. In those types of spray heads, the power level and possibly the electrode shape could be varied to obtain different coatings.

Other types of spray heads will spray a coating material through a flame. In these types of spray heads, the shape and temperature of the flame could be varied to obtain different coatings.

Of course, many other types of process conditions and material variations could also be accomplished to vary the coatings applied to a part. However, coating multiple parts in rapid succession during a single thermal cycle of an environmental chamber will tend to contribute to the repeatability and precision of the control of the process parameters. And having a part mounting apparatus capable of holding multiple rotating parts makes this possible.

Moreover, when multiple parts are processed within an environmental chamber at the same time, it is only necessary to increase the operating temperature within the environmental chamber up to the desired operational temperature a single time in order to conduct multiple part processing operations. This can reduce the cost of conducting the parts processing operations because a lesser amount of consumables would be used to heat the environmental chamber to the operating temperature. Furthermore, some of the materials used in the processing operations themselves might also be conserved when multiple parts are being processed during a single part processing operation.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A part mounting apparatus, comprising:
a base frame;
a rotation input shaft mounted on the base frame;
a plurality of part mounting devices that are rotatably mounted on the base frame, wherein the plurality of part mounting devices are operatively coupled to the rotation input shaft such that all of the part mounting devices rotate together with the rotation input shaft;
a first drive belt that is operatively coupled to the rotation input shaft and at least one of the plurality of part mounting devices; and
a second drive belt that is operatively coupled to the at least one of the plurality of part mounting devices, and to at least one other of the plurality of part mounting devices.

2. The part mounting apparatus of claim 1, wherein the plurality of part mounting devices are operatively coupled to the rotation input shaft such that all of the part mounting devices rotate at the same rotational speed.

3. The part mounting apparatus of claim 2, wherein the plurality of part mounting devices are operatively coupled to the rotation input shaft such that all of the part mounting devices rotate in the same rotational direction.

4. The part mounting apparatus of claim 1, wherein the plurality of part mounting devices are operatively coupled to the rotation input shaft such that all of the part mounting devices rotate in the same rotational direction.

5. The part mounting apparatus of claim 1, further comprising a motor coupled to the rotation input shaft.

6. The part mounting apparatus of claim 5, further comprising a motor controller that controls a rotational speed of the motor.

7. The part mounting apparatus of claim 1, wherein the first drive belt is physically coupled to the rotation input shaft and to a first one of the plurality of part mounting devices, and wherein the second drive belt is physically coupled to the first one of the plurality of part mounting devices, and to more than one of the remaining ones of the plurality of part mounting devices.

8. The part mounting apparatus of claim 1, wherein the first drive belt is physically coupled to the rotation input shaft and to a first one of the plurality of part mounting devices, and wherein the second drive belt is physically coupled to all of the plurality of part mounting devices.

9. The part mounting apparatus of claim 1, wherein the first drive belt is physically coupled to the rotation input shaft and to a first one of the plurality of part mounting devices, wherein the second drive belt is physically coupled to the first part mounting device and a first subset of the remaining ones of the plurality of part mounting devices, and further comprising a third drive belt that is physically coupled to a second subset of the remaining ones of the plurality of part mounting devices.

10. The part mounting apparatus of claim 9, wherein the third drive belt is also coupled to one of the part mounting devices which is a part of the first subset of the plurality of part mounting devices.

11. The part mounting apparatus of claim 1, wherein the rotation input shaft is a part of one of the part mounting devices.
